(19) United States
(12) Patent Application Publication
(10) Pub. No.: US 2003/0019292 A1
(43) Pub. Date: Jan. 30, 2003

(54) Aircraft fuel level gauge

(76) Inventors: Bruce Robinson, Ft. Wayne, IN (US); Edgar Douglas Kenna, Ft. Wayne, IN (US); Kenneth F. Cherry, toledo, OH (US)

Correspondence Address: Kenneth F. Cherry, 1533 Eastgate, Toledo, OH, 43614, US

(21) Appl. No.: 09/911,223

(22) Filed: Jul. 24, 2001

(51) Int. Cl. G01F 23/00

(52) U.S. Cl. 73/293

(57) ABSTRACT

This invention utilizes transparent plastic probes or a single multi-level probe, immersed in a fuel tank to detect fuel level. A light source and light sensing element is incorporated with the level probe so that as liquid touches the immersed end of the probe a change in reflective light occurs which results in a change in the electrical output of each light sensing device. The resulting signals from the light sensing devices are converted for use in fuel level gagging and for use by flight computers and similar devices. The invention also includes corporation of static electricity suppressing. coatings and an encasement cage to reduce the effect of fuel foam and fuel level fluctuations to due movement of fuel in the tank resulting from vehicle movement.

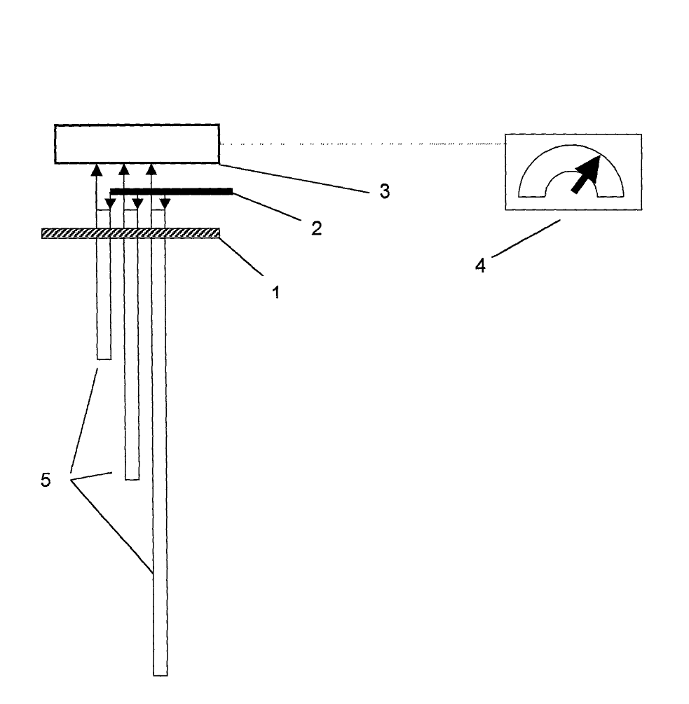

The device provides a safe alternative to fuel level measuring systems that have wires or other conductors of electrical energy extending into fuel tank.

### CROSS REFERENCE TO RELATED APPLICATIONS

None

### STATEMENT REGARDING FEDERALLY SPONSORED RESEARCH AND DEVELOPMENT

None

### REFERENCE TO MICRO FISH APPENDIX

None

### BACKGROUND OF THE INVENTION

Prior to the introduction of the invention aircraft fuel tanks commonly have level sensing devices, which use floats and internal electrical apparatus to provide an electronic signal that is converted to a fuel level shown on the dashboard, and the signal may also be used to inform an onboard computer of the fuel status. The use of internal electrical devices with floats in fuel tanks provides an opportunity for induced current or short circuits of sufficient energy causing a potential fire safety hazard. The safety hazard primarily relates to ignition sources within the fuel tank. Most present configurations of mechanical to electrical signal conversion also have the potential of providing a pathway allowing electric current to enter the fuel tank under some foreseeable circumstances.

Transparent probes have been used without electronic sensing devices for level indication in lead acid batteries and small engine gasoline tank as well as other similar applications.

### BRIEF SUMMARY OF THE INVENTION

This invention uses throughout the structure the known principal of detecting a liquid surface by visual means using a transparent plastic or glass probe. In use the probe will show a different amount of reflective light when the probe when it is immersed or when it is not immersed. By using a single probe various individual levels, or multiple probes an effective continuous liquid level reading, can be obtained. This reading is converted to a digital or approximate analog signal by using light sensing elements located on one surface of the transparent level sensing unit. The positioning of the light sensing electrical devices inside of the fuel tank is accomplished in a fashion to prevent any introduction of electric current into the vapor space of the fuel tank. This configuration provides an effective, viable and safe alternative to the use of mechanical or mechanical/electrical devices within the fuel tank.

### BRIEF DESCRIPTION OF THE DRAWING

The FIGURE depicts the device

1 shows a mounting means.

2 shows the light source assembly

3 shows the light sensing assembly

4 shows a level gauge representing the avionics interface

5 shows the transparent material probes passing through the mounting means

### DETAILED DESCRIPTION OF THE INVENTION

It is a known property of several transparent materials that when these materials are formed into a rod like structure they can be used for the visual detection of liquid levels. In practice a transparent rod with one end being essentially flat and smooth with the other end of the rod being flat and smooth, or of a predetermined geometric shape the rod can be used for liquid level detection. For the purpose of this description the end where light enters will be called the upper end and the end immersed into the liquid will be called lower end. When light source is available and the lower end is not immersed in liquid reflection of the light occurs in such a manner that it can be visually detected by looking at the upper end. When the lower end is immersed in a liquid the change in change in reflected light is noted in the upper end.

A group of similar rods of different length or a shape with a stepped configuration in a single transparent piece of material is known to allow the detection of multiple levels in a liquid.

The production of foam in the fuel as well as fuel level fluctuations at a point in the tank resulting from movement of the vehicle can be reduced by enclosing the probe with a device extending generally from the entrance point of the probe into the fuel tank to the lowest level of the probe. This enclosure may be a tightly woven screen, a tube with slits or similar construction. A cylindrical enclosure having vent holes or openings at the top and bottom can also serve a similar function.

Static discharges may be a concern in some fuel tank applications. The production of static electricity depends on the conductivity of the fluid, the amount of fluid motion and other factors. Providing a conductive path for the discharge of static electricity would be advantageous in some applications. The conductive path may be formed by the application of a conductive coating or encasement and a conductive jacket. The conductive coating may be something as simple as depositing a metallic film that can be vacuum deposited painted or another manner applied to the exterior surfaces of the device. This coating may be applied to the actual probe as well as to the tubular device to reduce the effects of foam or local level fluctuations, when such a device is used in conjunction with a probe. It is generally advantageous to provide a conducting surface from the fuel to the interior of the metallic fuel tank or otherwise incorporated to the static suppression system for the fuel system. This device must be mounted to the fuel tank. A mounting means that prevents fuel leakage is a preferred element of the invention. This mounting means may be constructed to fit an existing fuel tank opening.

A non-smooth surface on the exterior side of the probe and or to tubular mechanism may assist in inhibiting the interference caused by foam by providing a surface appropriate to assist in local foam distribution.

The light source may be of any appropriate type. The is a preferred embodiment of this invention to use light emitting diodes for the light source because of the low power consumption, reliability and low operating temperature. The color chosen should be white, a color especially suited for particular fuel or infrared. The light source may be from a single light-emitting element or from several. The advantage of several light emitting elements is in the inclusion of redundant elements to enhance reliability. It is a preferred embodiment of the invention to utilize either direct lighting of the measuring element surface or transmission of light via fiber optics.

Detection of reflective light by an appropriate detector is also a preferred embodiment of this invention. For the purposes of thi patent the terms detection and sensing have the same meaning. Available detector include photo transistors, photo diodes and other electronic light sensing devices which have a change in electrical resistance or production of an electrical current as a result of exposure to a light source. The light detecting element and light producing element must be selected to have compatible frequencies so that the light reflected within the probe will be of adequate intensity and frequency to activate the light sensing device and result in a measurable electrical change in the light sensing device as a function of reflective light changes occurring when the selected probe element is immersed in or not immersed in the fuel in the tank. A single light source and or a single light sensor can be used. When a single sensor is used the sensor must be selected to provide a variable electrical output which varies as the liquid level changes producing corresponding changes in the reflected light in the probes. Electrical signal modification may be required to produce the desired signal required by the avionics.

In a typical application a plurality of sensing elements is chosen. For example, twelve elements are selected. The elements are cut in varying lengths to correspond to twelve equal levels between the tank full and tank empty condition. The probe elements are mounted through a fitting in the top of the fuel tank and the longest extends to nearly the bottom of the tank. The exterior of the elements can be coated with a conductive material for the dissipation of static and the conductive material will be bonded electrically to the interior of the tank.

Each of the twelve elements has a separate light emitting source and detector element. These elements will be directly mounted on the individual probes. An electrical source of appropriate voltage and current to power the light emitting sources will be provided. The light detecting devices will be connected electronically to a circuit that will provide an output compatible with the aircraft avionics. As each of the twelve levels is immersed in fuel a change in the output of each respective light-detecting device will occur. This change in output was then used by the interface circuit to provide fuel level information to an appropriate gauge or electrical interface for the purposes of display and use by other aircraft systems. These aircraft systems will include devices such as a flight computer and low fuel level warning systems.

It is recognized that this technology may be applicable to surface, marine and spacecraft vehicles.

We claim

1 A liquid level-measuring device suitable for aircraft use comprising a multi-level sensing transparent probe, with probing having sensing level surfaces at various levels in the fuel tank
a light-emitting element optically connected to the surface of the sensing elements outside of the fuel tank
a light sensing device to electronically sense the reflected light in the sensing elements as a function of contact or non-contact with the fuel,
a conversion device to convert the electrical signals in the light detecting elements into a signal to be used in the functions in the output of a conventional fuel level sensor
a power source providing suitable electric current to the light source or sources and light detectors.
a mounting means to secure the apparatus to a fuel tank.
the above elements configured and mounted to provide a fuel level indication function.

2 The invention of claim 1 including a conductive coating on the probe for purpose of dissipating static electricity.

3 Invention of claim 1 having an encasement for the probe for the purpose of reducing the effect of fuel foam on the fuel level readings.

4 The invention of claim 1 wherein all elements associated with the device located in the fuel tank have a coating for the dissipation of static electricity.

5 The invention of claim 1 wherein the light source is a light emitting diode emitting white, color or infrared light.

6 The invention of claim 1 having a light detecting element, which has an electrical output, which detects white, or color or infrared light.

7 The invention of claim one used in surface, marine or spacecraft vehicles.
